(19) United States
(12) Patent Application Publication
(10) Pub. No.: US 2013/0091908 A1
(43) Pub. Date: Apr. 18, 2013

(54) DEVICE FOR UNLOCKING LOCK RECOGNIZING PUNCHED CARD

(71) Applicant: Byung-Sung Lee, Yongin-si (KR)

(72) Inventor: Byung-Sung Lee, Yongin-si (KR)

(73) Assignee: MAZETECH CO LTD, INCHEON-SI (KR)

(21) Appl. No.: 13/806,170

(22) PCT Filed: Jun. 23, 2010
(86) PCT No.: PCT/KR10/04062

§ 371 Date: Dec. 21, 2012

(51) Int. Cl. E05B 35/00

(52) U.S. Cl. CPC E05B 35/007
USPC 70/344

(57) ABSTRACT

A device for unlocking a lock recognizing a punched card includes a card recognition unit and an unlocking unit. The card recognition unit comprises: a base plate into which a card provided with a plurality of holes is inserted; a moving plate which is coupled to the base plate in such a manner that the moving plate can move closer to or away from the base plate; a first recognition unit that recognizes the holes in the card depending on insertions into the holes in the card in the process of the moving plate moving closer to the base plate; and a second recognition unit that recognizes the absence of a hole in the card based on contact with the area of the card lacking holes in the process of the moving plate moving closer to the base plate. The unlocking unit unlocks the lock based on the recognition results of the first and second recognition units.

### TECHNICAL FIELD

The present invention relates to a locking/unlocking device, and more particularly, to a locking/unlocking device for unlocking a door by means of punched-card recognition.

### BACKGROUND ART

In general, a door lock is a device to lock a door or unlock the locked door. In recent years, with the attempts to improve reliability of security and convenience of use, the use of digital door locks of various types, including key-input type, fingerprint-recognition type, RF type, card-recognition type, and so on, has been gradually increased. The conventional digital door locks of the key-input type, RF type, or card-recognition type fail to function if a malfunction or a defect occurs in a circuit or the power source discharges. Korean Registration Patent No. 0528505, titled “Door Lock Device”, discloses a card-recognition type door lock. According to this prior art, the door lock device is unlocked when a number of punched holes on a card match with punches protruding from a moving plate of the door lock. However, the card with punched holes, which applies to the conventional technique, may be easily duplicated.

In other words, as long as punches protruding inside a door lock device match with punched holes of a card, the door lock is unlocked. Thus, if a malicious user inserts a card duplication means into a card insertion unit and turns a handle to copy positions of the punches descending in association with the rotation movement of the handle, the user is able to create a duplicate card using the copied positions. In addition, the door lock can be unlocked using a card with punched holes all over the surface, and thus it is easy to create a duplicate card. Thus, the conventional card-recognition type door lock using a card with punched holes is vulnerable to security issues.

### TECHNICAL SOLUTION

The present invention provides a punched-card recognition locking/unlocking device which includes recognition units for recognizing hole-pattern and absence of holes of a card with punched holes and is capable of unlocking a lock only when all recognition units succeed in recognition.

In addition, the present invention also provides a punched-card recognition locking/unlocking device which recognizes the presence and absence of holes of a card in a mechanical manner and unlocks based on the recognition results also in a mechanical manner, so that unlocking process is possible even when a defect or a malfunction occurs in a circuit or power source discharges.

In one general aspect of the present invention, there is provided a punched-card recognition locking/unlocking device, including: a card recognition unit configured to comprise a base plate configured to have a card with a plurality of holes inserted thereinto, a moving plate configured to be coupled to the base plate in such a manner that the moving plate moves closer to or away from the base plate, a first recognition unit configured to recognize the holes on the card based on insertions into the holes of the card while the moving plate moves closer to the base plate, and a second recognition unit configured to recognize absence of holes on the card based on contact with the area of the card lacking holes while the moving plate moves closer to the base plate; and an unlocking unit configured to unlock a lock based on recognition results of the first recognition unit and the second recognition unit.

According to the present invention, the locking/unlocking device is unlocked only when both the holes of the card and the area of the card lacking holes are recognized, and thereby a malicious user is prevented from easily estimating or duplicating positions of holes on the card. Accordingly, it becomes more difficult to replicate a card and hence security of the device may be enhanced. Further, the lock is unlocked in a mechanical way in the event of circuit malfunction or power source failure, so that convenience of use is improved.

Additional features of the invention will be set forth in the description which follows, and in part will be apparent from the description, or may be learned by practice of the invention.

### DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating a card-recognition locking/unlocking device according to an exemplary embodiment of the present invention.

FIG. 2 is an exploded perspective view illustrating the card-recognition locking/unlocking device shown in FIG. 1.

FIG. 3 is an enlarged perspective view illustrating a card recognition unit shown in FIG. 1.

FIG. 4 is an enlarged perspective view taken from a direction opposite the view of FIG. 3 illustrating the card recognition unit.

FIGS. 5 to 7 are cross-sectional views for explaining operation of a first recognition unit according to an exemplary embodiment of the present invention.

FIGS. 8 to 10 are cross-sectional views for explaining operation of a second recognition unit according to an exemplary embodiment of the present invention.

FIG. 11 is an enlarged perspective view illustrating a rotational body according to an exemplary embodiment of the present invention.

FIGS. 12 to 14 are cross-sectional views for explaining operation of a punched-hole card recognition locking/unlocking device according to an exemplary embodiment of the present invention.

FIG. 15 is an exploded perspective view illustrating another example of a card recognition unit according to an exemplary embodiment of the present invention.

FIG. 16 is a cross-sectional view of the card recognition unit shown in FIG. 15.

### MODE FOR INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

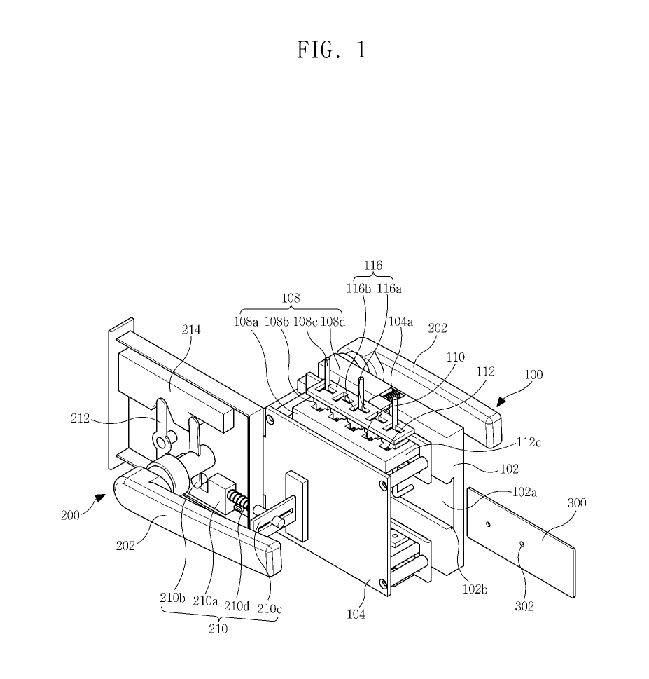

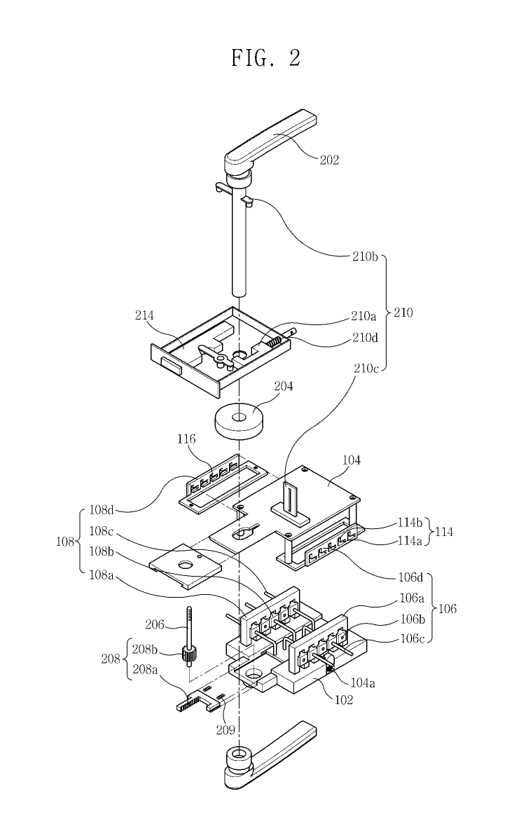

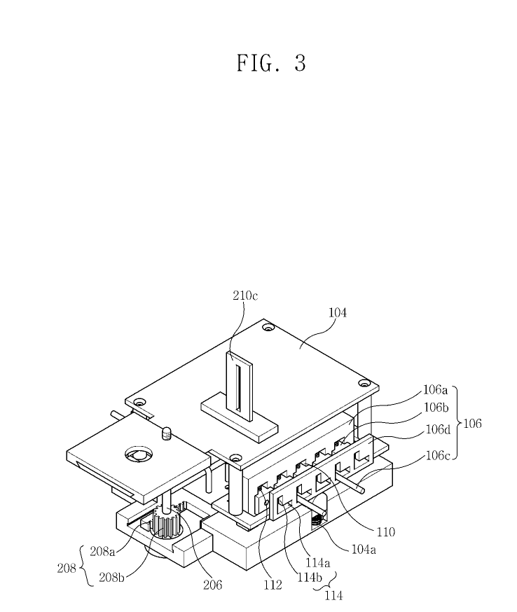

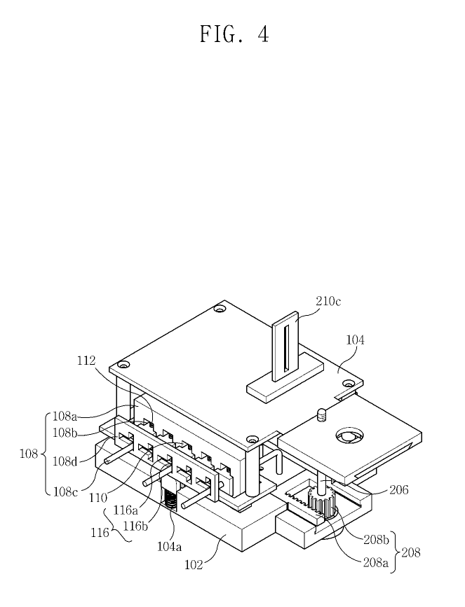

FIG. 1 is a perspective view illustrating a card-recognition locking/unlocking device according to an exemplary embodiment of the present invention. FIG. 2 is an exploded perspective view illustrating the card-recognition locking/unlocking device shown in FIG. 1. FIG. 3 is an enlarged perspective view illustrating a card recognition unit shown in FIG. 1, and FIG. 4 is an enlarged perspective view taken from a direction opposite the view of FIG. 3 illustrating the card recognition unit.

Referring to FIGS. 1 to 4, the punched-card recognition locking/unlocking device includes a card recognition unit 100 and an unlocking unit 200. The card recognition unit 100 includes a base plate 102, a moving plate 104, a first recognition unit 106, and a second recognition unit 108. A card 300 with a plurality of holes 302 is inserted into the base plate 102. The moving plate 104 is coupled to the base plate 102 in such a manner that it can be closer to or away from the base plate 102. The first recognition unit 106 recognizes the holes 302 on the card 300 when the first recognition unit 106 is inserted into the holes 302 while the moving plate 104 is moving closer to the base plate 102. The second recognition unit 108 recognizes the absence of holes in the card 300 based on contact with the area of the card 300 lacking holes while the moving plate 104 is moving closer to the base plate 102.

The unlocking unit 200 unlocks depending on recognition results from the first recognition unit 106 and the second recognition unit 108. The unlocking unit 200 unlocks when the first recognition unit 106 has recognized the holes 302 of the card 300 and the second recognition unit 108 has recognized the absence of the holes on the card 300.

The base plate 102 may have a card slot portion 102a allowing the card 300 to be inserted and a card guiding portion 102b for guiding the horizontal movement of the card 300 inserted through the card slot portion 102a.

The moving plate 104 which is being coupled to the base plate 102 in such a manner that it can move upward and downward may be provided with elastic force from an elastic member 104a, such as a compression spring, in a direction in which the moving plate 104 moves away from the base plate 102. In addition, the moving plate 104 moves downward in a direction toward the base plate 102, in association with external force, that is, the rotation movement of a handle, due to the insertion of the card 300. If it is determined that the card 300 is normal, the moving plate 104 moves in a direction parallel to the base plate 102. The first recognition unit 106 may include a first vertical frame 106a, first holders 106b, a first recognition bar 106c, and a first pattern plate 106d. The first vertical frame 106a is placed below the first base plate 102, and has a plurality of guiding holes 110.

The first holders 106b are accommodated within the respective guiding holes 110, and supported movably within the respective guiding holes 110. The first holders 106b are provided with elastic force in a direction toward the base plate 102. For example, the first holders 106b may be provided with elastic force from an elastic member 112, such as a compression spring, which is disposed in a vertical direction in each of the guiding holes 110.

The first recognition bar 106c has a protruding end bent in a direction toward the base plate 102, and is connected to each of some of the first holders 106b. The first pattern plate 106d is vertically positioned below the moving plate 104 in such a manner that it corresponds to the first vertical frame 106a.

The first pattern plate 106d includes first pattern holes 114 formed to have the first recognition bars 106c inserted thereinto and thereby guide the movement of each of the first recognition bars 106c such that the moving plate 104 is able to slide only when the protruding ends of the first recognition bars 106c are inserted into the holes 302 of the card 300 while the moving plate 104 is moving downward.

For example, the first pattern hole 114 may be formed by combination of a first guiding portion 114a that is a horizontally extending slot and a second guiding portion 114b that is a vertically extending slot, such that the first pattern hole 114 can be L-shaped.

Operation of the first recognition unit 106 will be described in detail below.

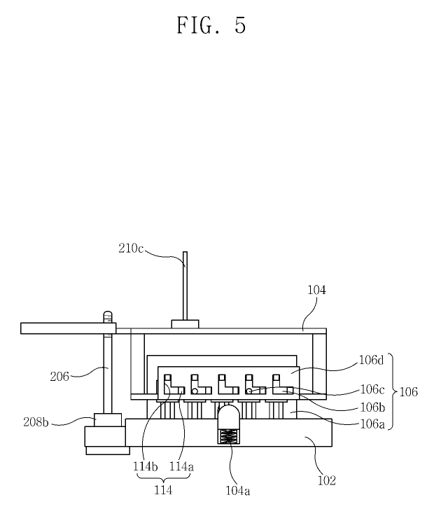

Referring to FIG. 5, the first holders 106b coupled with the first recognition bars 106c are supplied with elastic force from the compression spring in a direction toward the base plate 102, and thus each of the first recognition bars 106c is caught in a connecting portion between the first guiding portion 114a and the second guiding portion 114b.

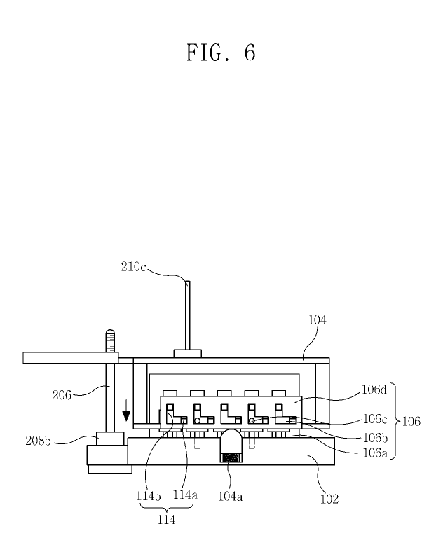

In this state, as shown in FIG. 6, when the moving plate 104 moves downward in a direction toward the base plate 102, the first pattern plate 106d moves downward along with the moving plate 104. At this time, if the card 300 has the holes 302, the first recognition bar 106c is moved toward the base plate 102 by the first holder 106b with elastic force in a direction toward the base plate 102 and is inserted into the hole 302 of the card 300.

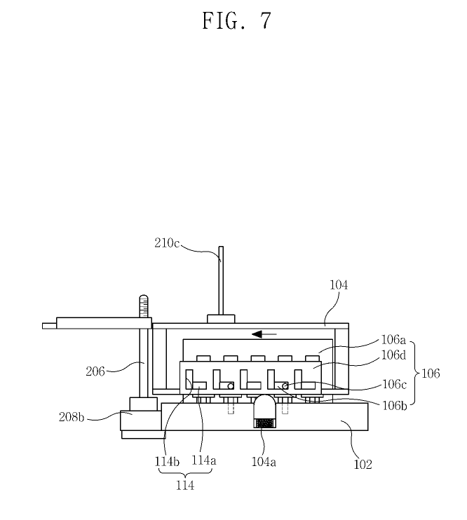

As such, when the first recognition bar 106c is moved by the distance the first pattern plate 106d moves, that is, by a depth of the hole 302 of the card 300, the position of the first recognition bar 106c remains in the same connection portion between the first guiding portion 114a and the second guiding portion 114b, and hence the first recognition bar 106c is able to be horizontally slid along the first guiding portion 114a. Consequently, the moving plate 104 is able to slidably move and, when an external force is applied, can be slid, as shown in FIG. 7.

On the contrary, if the card 300 does not have the holes 302, the first recognition bar 106c is moved from the connection portion between the first guiding portion 114a and the second guiding portion 114b to an upper portion of the second guiding portion 114b, and thus the moving plate 104 is unable to slidably move.

The second recognition unit 108 may include a second vertical frame 108a, second holders 108b, a plurality of second recognition bars 108c, and a second pattern plate 108d. The second vertical frame 108a is protruding vertically from the base plate 102, and includes a plurality of guiding holes 110.

The second holders 108b are accommodated within the respective guiding holes 110, and supported in such a manner that they can move along the interior of the respective guiding holes 110. In addition, the second holders 108b are provided with elastic force in a direction toward the base plate 102. For example, the second holders 108b may be supplied with elastic force from the elastic member 112, such as a compression spring, which is disposed vertically in each of the guiding holes 110.

The second recognition bars 108c, each, have a protruding end bent in a direction toward the base plate 102, and are coupled with each of some of the second holders 108b.

The second pattern plate 108d is placed and is vertically placed at a position corresponding to the second vertical frame 108a below the moving plate 104. The second pattern plate 108d includes second pattern holes 116 formed to have the second recognition bars 108c inserted thereinto and thereby guide the movement of each of the second recognition bars 108c, such that the moving plate 104 is able to slide only when the protruding ends of the second recognition bars 108c are in contact with the area of the card 300 lacking holes while the moving plate is moving downward.

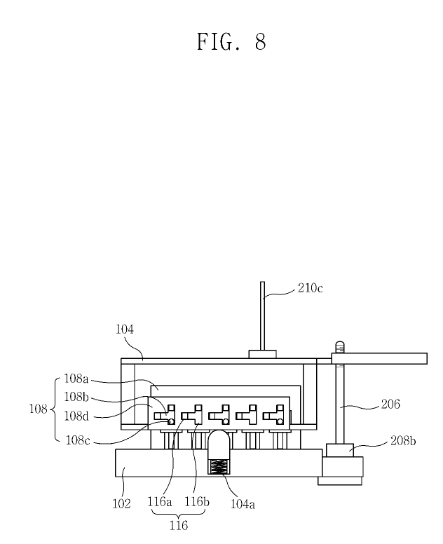

For example, the second pattern holes 116 may be [symbol] -shaped. As another example, the second pattern holes 116 may be formed by combination of a third guiding portion 116a that is a horizontally extending slot and a fourth guiding portion 116b that is a vertically extending slot, such that the second pattern holes 116 is [symbol] shaped, as shown in FIGS. 8 to 10. If the second pattern holes 116 are [symbol] shaped, a thickness of the card can be detected.

Operation of the second recognition unit 108 will be described in detail below.

Referring to FIG. 8, since the second holders 108b coupled with the second recognition bars 108c are provided with elastic force from the elastic member 112, such as a compression spring, in a direction toward the base plate 102, each of the second recognition bars 108c is caught in a lower portion of the fourth guiding portion 116b.

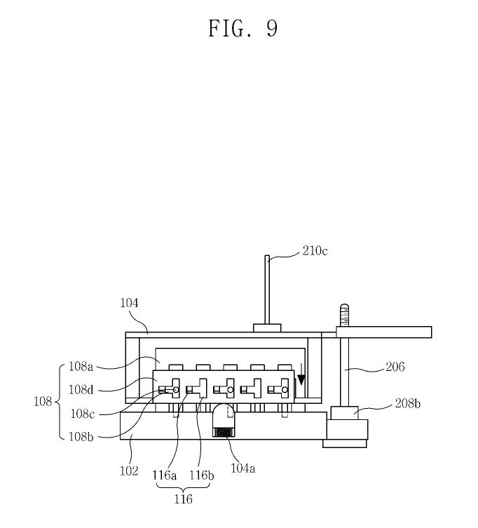

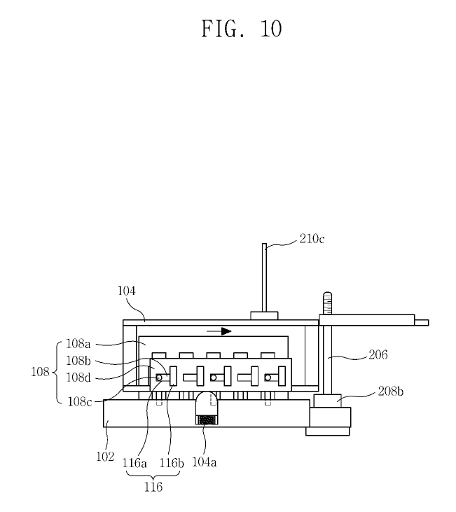

In this state, as shown in FIG. 9, when the moving plate 104 moves in a direction toward the base plate 102, the second holders 108b causes the second recognition bars 108c to tend to move in a direction toward the base plate 102. At this time, the second recognition bars 108c are not able to descend and each positioned at a connecting portion between the third guiding portion 116a and the fourth guiding portion 116b because they are blocked by the area of the card 300 lacking holes. Accordingly, the second recognition bars 108c are able to move horizontally along the third guiding portions 116a. Thus, the moving plate 104 is able to slidably move, and thus slide, as shown in FIG. 10, when an external force is exerted thereon.

On the contrary, since the second recognition bar 108c descends while being inserted into a hole of the card 300, which is formed on the area of the card 300 lacking holes, the second recognition bar 108c is caught in a lower portion of the fourth guiding portion 116b. Thus, the moving plate 104 is unable to slide.

In a case where the card 300 is abnormal and has a thickness different from that of a normal card, each of the second recognition bars 108c is dislocated from the connecting portion between the third guiding portion 116a and the fourth guiding portion 116b and located at the fourth guiding portion 116b, and thereby the moving plate 104 is unable to slide.

As such, only when both the first recognition unit 106 has successfully recognized the holes of the card and the second recognition unit 108 has successfully recognized the absence of holes in the card, the moving plate 104 is able to slide.

Thus, in a locking/unlocking device of an existing type in which only the holes are recognized, a pattern of hole locations on a card is readily copied and thus creating a duplicate card may be easily carried out. However, according to the present invention, recognition bars are placed at locations corresponding to holes of a card and the area of the card lacking holes. Thus, when a duplication of a card is attempted, the recognition bars for recognizing the area of the card lacking holes can make it difficult to create a duplicate since they look like recognition bars for recognizing holes of the card, and thereby security for the card can be improved.

The unlocking unit 200 may include handles 202, a rotational body 204, a latch 206, a latch moving unit 208, a guiding unit 210, and a lock moving member 212. Here, the handles 202 are formed to protrude from an entrance door or safety door, and to be rotated by an external force.

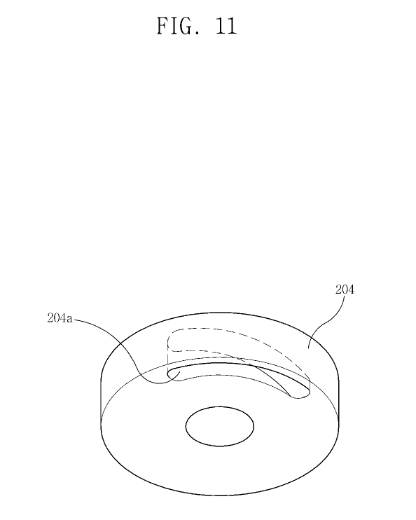

The rotational body 204 fixed onto the handles 202 rotates in association with rotation of the handle 202, and is formed to have a cam groove 204a with a concave surface toward the moving plate 104, which has depths gradually varying with respect to the moving plate 104, as shown in FIG. 11.

The latch 206 is formed to pass and be inserted through the cam groove 204a in such a manner that it can move forward and backward relative to the cam groove 204a. The latch 206 is coupled to the moving plate 104 via a screw connection, such that the latch 206 is pressed by the rotational body 204 that moves in association with the rotation of the handle 202 and moves the moving plate 104 downward in a direction toward the base plate 102. In addition, the latch 206 is moved inside the cam groove 204a by the latch moving unit 208 which moves in association with the insertion of the card.

Here, the latch moving unit 208 includes a rack gear 208a and a pinion gear 208b. The rack gear 208a slides while being pushed against the card 300 upon insertion of the card 300. The pinion gear 208b has the latch 206 fixed onto its center of rotation and rotates in engagement with the rack gear 208a, thereby rotating the latch 206. Such configuration allows the pinion gear 208b to rotate in association with the sliding movement of the rack gear 208a which is caused by the insertion of the card 300, and thereby the latch 206 is enabled to move along the interior of the cam groove 204a.

In this case, the card should be able to be returned upon the completion of the unlocking process. Thus, the rack gear 208a is formed to be provided with elastic force in a direction opposite to a card insertion direction. The rack gear 208a has a tension spring 209 mounted on a side toward the base plate 102 and the base plate 102 also has a tension spring 209 mounted on a side toward the rack gear 208a.

The guiding unit 210 guides the sliding movement of the moving plate 104 when the handle 202 turns. The guiding unit 210 includes a moving block 210a, a lever 210b, a connection member 210c, and an elastic member 210d.

Here, the moving block 210a is positioned close to the handle 202, and the lever 210b is mounted on the handle 202 to move the moving block 210a and the lock moving member 212 when the handle 202 turns.

In addition, the connection member 210c is protruding from the moving plate 104 and connected with the moving block 210a, so that it can substantially slidably move the moving plate 104 in association with the movement of the moving block 210a. The connection member 210c has a groove in a portion connected with the moving block 210a such that the forward and backward movements of the moving plate 104 can be smoothly performed. Moreover, the elastic member 210d is provided between the moving block 210a and the connection member 210c to allow the moving plate 104 to slidably return to its original position.

The lock moving member 212 moves a lock 214 in association with the guiding unit 210. The lock moving member 212 turns in association with the movement of the moving block 210a, thereby moving the lock 214 to unlock, and then returns to its original position in accordance with the return movement of the lock 214 due to the handle returning to its original position.

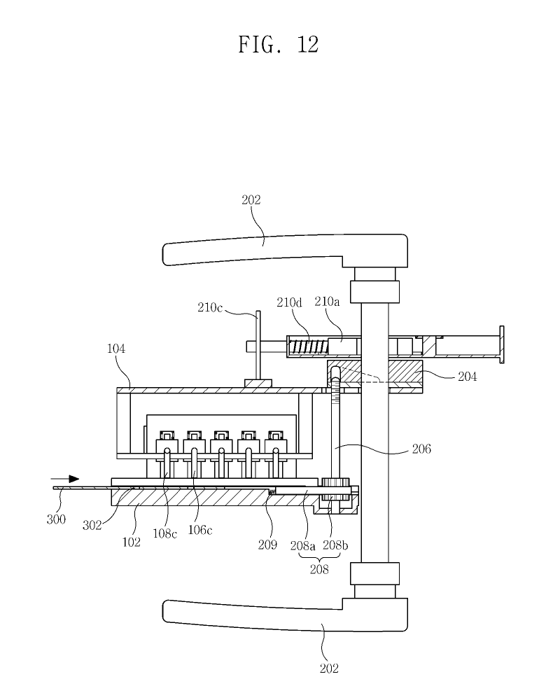

FIGS. 8 to 13 are cross-sectional views illustrating a card-recognition locking/unlocking device according to an exemplary embodiment of the present invention. With reference to FIGS. 8 to 13 in conjunction with FIGS. 1 to 7, operational relationships between elements of the locking/unlocking device will be described as below.

First, referring to FIG. 8, in a state in which a card 300 is ready to be inserted, if the card 300 with a plurality of holes is inserted into the card slot unit 102a of the base plate 102 and then is slid along the card guiding portion 102b, the rack gear 208a slides in conjunction with the sliding movement of the card 300. Thereafter, the pinion gear 208b in engagement with the rack gear 208a turns, and accordingly, the latch 206 is rotated and moves along the interior of the cam groove 204a.

In addition, when the latch 206 moves into the cam groove 204a, the rotational body 204 is rotated in association with the rotational movement of the latch 206, and then the handle 202 coupled with the rotational body 204 turns by a predetermined angle. When the handle 202 is applied an external force in such a state where the handle 202 turns at a predetermined angle from its original position, the moving plate 104 coupled to the latch 206 via a screw connection is pressed without rotation, in accordance with the turning movement of the handle 202, so that the moving plate 104 tends to move downward in a direction toward the base plate 102.

In this state, as shown in FIG. 9, if both the first recognition unit 106 and the second recognition unit 108 have successfully recognized the presence and absence of holes on the card 300, respectively, the moving plate 104 is placed in a slidable state. More specifically, as shown in FIG. 6, when the first recognition unit 106 has successfully recognized holes on the card 300, so that the first recognition bars 106c are placed in the first guiding portion 114a, and when the second recognition unit 108 has successfully recognized the absence of holes on the card 300, so that the second recognition bars 108c are placed in the third guiding portion 116a, the moving plate 104 is placed in a slidable state.

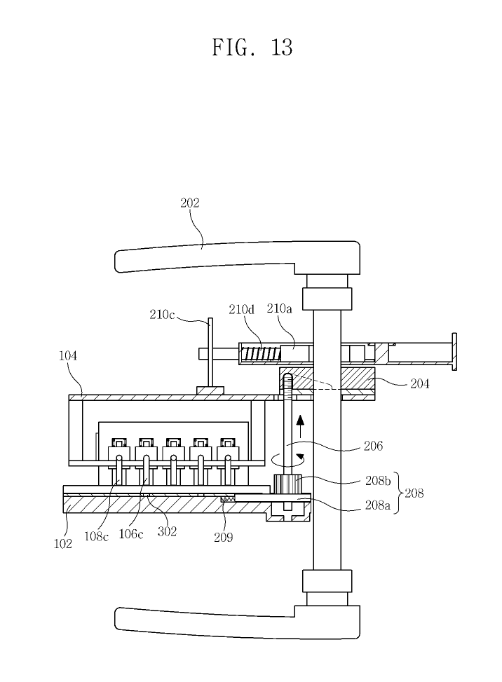

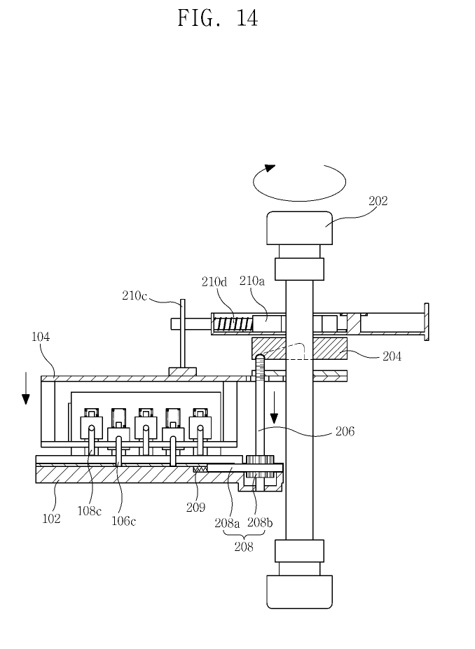

When a constant external force is applied to the moving plate 104 in a slidable state, the handle 202 turns by a greater angle, and accordingly, as shown in FIG. 13, the moving plate 104 slides, so that the moving block 210a connected to the connection member 210c is moved. Then, the lock moving member 212 is rotated in accordance with the movement of the moving block 210a, and thereby the locking state is unlocked.

Thereafter, when the external power is released from the handle 202, the moving block 210a returns to its original position by an elastic force from the elastic member 210d connected thereto. As a result, in association with the returning movement of the moving block 210a, the lock moving member 212 is rotated to return to its original position and thereby the lock 214 is returned to lock position. In association with the movement of the moving block 210a, the moving plate 104 connected to the moving block 210a via the connection member 210c is slid back to its original position.

As described above, the present invention enables the recognition of the presence and absence of holes on the card in a mechanical manner, without additional power source, and unlocks the locking state or returns the door to locking position according to the recognition results, so that the locking/unlocking device is able to function normally even under the condition where a malfunction or a defect occurs in a circuit or power source discharges, whereby convenience of use is enhanced.

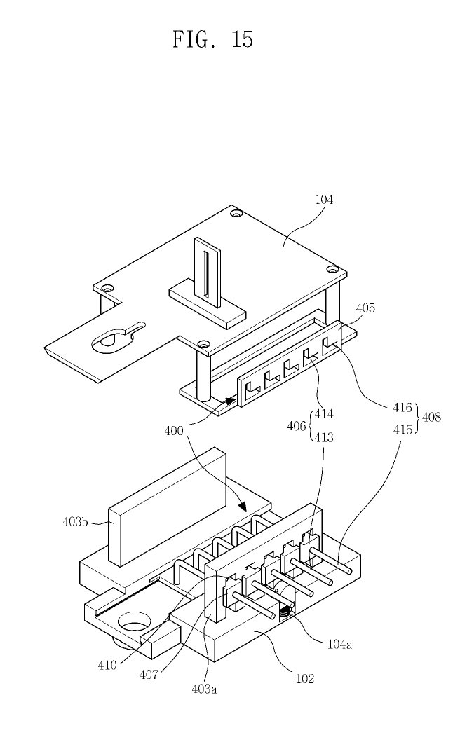

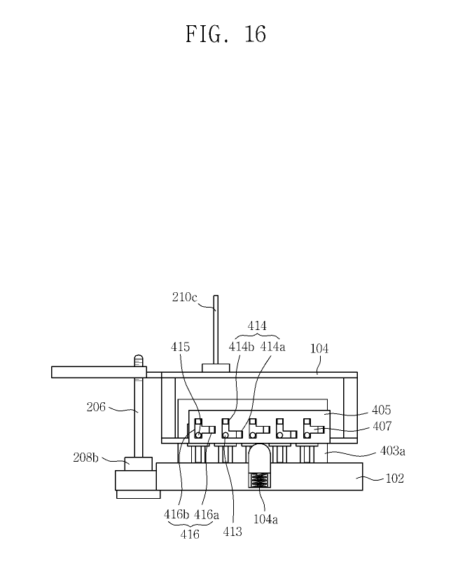

FIG. 15 is an exploded perspective view illustrating another example of a card recognition unit according to an exemplary embodiment of the present invention, and FIG. 16 is a cross-sectional view of the card recognition unit shown in FIG. 15.

Referring to FIGS. 15 and 16, the card recognition unit 400 includes a first recognition unit 406 and a second recognition unit 408 which are disposed on the same side of the card recognition unit 400, whereas the first recognition unit 106 and the second recognition unit 108 which are respectively arranged in opposite sides of the card recognition unit 100 according to the above-described exemplary embodiment of the present invention.

For this arrangement, a base plate 102 has vertical frames 403a and 403b, each vertically protruding upward from each side of the base plate 102, and only one 403b of the vertical frames 403a and 403b include a plurality of guiding holes 410. Holders 407 are accommodated within the respective guiding holes 410, and supported in such a manner that they can move along the interior of the corresponding guiding holes 410. The holders 407 are provided with elastic force in a direction toward the base plate 102. In addition, a single pattern plate 405 is placed at a position corresponding to the vertical frame 403a having the holders 407 mounted. The pattern plate 405 is vertically positioned below the moving plate 104.

The first recognition unit 406 includes first recognition bars 413 and first pattern holes 414. The first recognition bars 413 are coupled to each of some of the holders 407, and each has a protruding portion bent in a direction toward the base plate 102.

The first pattern holes 414 are formed on the pattern plate 405 at positions corresponding to the first recognition bars 413. The first pattern holes 414 are formed to have the first recognition bars 413 inserted thereinto and thereby guide the movement of each of the first recognition bars 413 such that the moving plate 104 is able to slide only when the protruding portions of the first recognition bars 413 are inserted into the holes of the card while the moving plate 104 moves toward the pattern plate 405, for example, moves downward. For example, the first pattern holes 414 may be formed by combination of a first guiding portion 414a that is a horizontally extending slot and a second guiding portion 414b that is a vertically extending slot, such that the first pattern hole 414 can be L-shaped.

The second recognition unit 408 includes second recognition bars 415 and second pattern holes 416. The second recognition bars 415 are, respectively, coupled to the remaining holders 407 and each has one protruding portion bent in a direction toward the base plate 102.

The second pattern holes 416 are formed on the pattern plate 405 at positions corresponding to the second recognition bars 415. The second pattern holes 416 have the second recognition bars 415 inserted thereinto and thereby guide the movement of the second recognition bars 415 such that the moving plate is able to slide only when the protruding portions of the second recognition bars 415 are in contact with the area of the card lacking holes while the moving plate 104 moves downward. For example, each of the second pattern holes 416 may be formed by combination of a third guiding portion 416a which is an horizontally extending slot and a fourth guiding portion 416b which is an vertically extending slot, such that the second pattern hole 416 is formed I-shaped.

The hole recognition process by means of cooperation of the first recognition bars 413 with the first pattern holes 414 during the moving plate 104 descends is performed in the same manner as the hole recognition process by the first recognition unit 106 described above. In addition, while the moving plate 104 is moving downward, the hole-absence recognition process by means of cooperation of the second recognition bars 415 with the second pattern holes 416 is performed in the same manner as the hole-absence recognition process by the second recognition unit 108 described above.

Moreover, the first recognition bars 413 and the second recognition bars 415 are alternately placed, and also the first pattern holes 414 and the second pattern holes 416 are alternately positioned, but the positions of the first and second recognition bars 413 and 415 and positions of the first and second pattern holes 414 and 416 are not limited thereto.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A punched-card recognition locking/unlocking device, comprising:
a card recognition unit configured to comprise a base plate configured to have a card with a plurality of holes inserted thereinto, a moving plate configured to be coupled to the base plate in such a manner that the moving plate moves closer to or away from the base plate, a first recognition unit configured to recognize the holes on the card based on insertions into holes of the card while the moving plate moves closer to the base plate, and a second recognition unit configured to recognize absence of holes on the card based on contact with the area of the card lacking holes while the moving plate moves closer to the base plate; and
an unlocking unit configured to unlock a lock based on recognition results of the first recognition unit and the second recognition unit.

2. The punched-card recognition locking/unlocking device of claim 1, wherein the first recognition unit is configured to comprise
a first vertical frame vertically protruding from the base plate and configured to have a plurality of guiding holes formed thereon,
a plurality of first holders configured to be supported movably within the respective guiding holes, and to be provided with elastic force in a direction toward the base plate,
a plurality of first recognition bars, each being configured to be coupled to each of some of the first holders and to have an protruding portion bent in a direction toward the base plate, and
a first pattern plate vertically placed below the moving plate at positions corresponding to the first vertical frame, and configured to have first pattern holes formed to have the first recognition bars inserted thereinto and thereby guide a movement of each of the first recognition bars, such that the moving plate is able to slide only when the protruding portions of the first recognition bars are inserted into the holes of the card while the moving plate moves closer to the base plate.

3. The punched-card recognition locking/unlocking device of one of claims 1 and 2, wherein the second recognition unit is configured to comprise
a second vertical frame vertically protruding from the base plate and configured to have a plurality of guiding holes formed thereon,
a plurality of second holders configured to be supported movably within the respective guiding holes and to be provided with elastic force in a direction toward the base plate,
a plurality of second recognition bars, each being configured to be coupled to each of some of the second holders and to have a protruding portion bent in a direction toward the base plate, and
a second pattern plate vertically placed below the moving plate at a position corresponding to the second vertical frame, and configured to have second pattern holes formed to have the second recognition bars inserted thereinto and thereby guide a movement of each of the second recognition bars, such that the moving plate is able to slide only when the protruding portions of the second recognition bars are in contact with the area of the card lacking holes while the moving plate moves closer to the base plate.

4. The punched-card recognition locking/unlocking device of claim 1, wherein
the card recognition unit is configured to comprise a vertical frame vertically protruding from the base plate and having a plurality of guiding holes formed thereon, a plurality of holders supported movably within the respective guiding holes and provided with elastic force in a direction toward the base plate, and a pattern plate vertically placed below the moving plate at a position corresponding to the vertical frame,
the first recognition unit is configured to comprise a plurality of first recognition bars, each being coupled to each of some of the holders and having a protruding portion bent in a direction toward the base plate, and first pattern holes formed on the pattern plate to have the first recognition bars inserted thereinto and thereby guide a movement of each of the first recognition bars such that the moving plate is able to slide only when the protruding portions of the first recognition bars are inserted into the holes of the card while the moving plate moves closer to the base plate, and
the second recognition unit is configured to comprise a plurality of second recognition bars, each being coupled to each of the remaining holders and having a protruding portion bent in a direction toward the base plate, and second pattern holes formed to have the second recognition bars inserted thereinto and thereby guide a movement of each of the second recognition bars, such that the moving plate is able to slide only when the protruding portions of the second recognition bars are in contact with the area of the card lacking holes while the moving plate moves closer to the base plate.

5. The punched-card recognition locking/unlocking device of claim 1, wherein the unlocking unit is configured to comprise
a handle turning by an external force,
a rotational body fixed onto the handle and having a cam groove with a concave surface toward the moving plate and with depths gradually varying with respect to the moving plate,
a latch coupled to the moving plate via a screw connection and configured to be able to move forward and backward with respect to the cam groove and to be pressed when the handle is turning and to thereby move the moving plate in a direction toward the base plate,
a latch moving unit configured to rotate and move the latch along an interior of the cam groove when the card is inserted,
a guiding unit configured to guide a sliding movement of the moving plate when the handle is turning and
a lock moving member configured to move a lock in association with the guiding unit.

6. The punched-card recognition locking/unlocking device of claim 5, wherein the latch moving unit is configured to comprise
a rack gear configured to slide upon the insertion of the card and be provided with elastic force in a direction opposite to a direction in which the card is inserted and
a pinion gear configured to have the latch fixed on its center of rotation and to rotate the latch while rotating in engagement with the rack gear.

7. The punched-card recognition locking/unlocking device of claim 5, wherein the guiding unit is configured to comprise
a moving block,
a lever configured to move both the moving block and the lock moving member when the handle is turning,
a connection member protruding from the moving plate and being connected to the moving block and
an elastic member configured to enable the moving plate to slidably return to its original position.
